(19) United States
(12) Patent Application Publication
(10) Pub. No.: US 2014/0325427 A1
(43) Pub. Date: Oct. 30, 2014

(54) ELECTRONIC DEVICE AND METHOD OF ADJUSTING DISPLAY SCALE OF IMAGES

(71) Applicant: HON HAI PRECISION INDUSTRY CO., LTD., New Taipei (TW)

(72) Inventor: HO-LEUNG CHEUNG, Santa Clara, CA (US)

(73) Assignee: HON HAI PRECISION INDUSTRY CO., LTD., New Taipei (TW)

(21) Appl. No.: 14/201,946

(22) Filed: Mar. 10, 2014

(30) Foreign Application Priority Data
Apr. 30, 2013 (TW) 102115534

(51) Int. Cl. G06F 3/0484; G09G 5/373; G06F 3/0481

(52) U.S. Cl. CPC G06F 3/04847; G06F 3/0481; G09G 5/373
USPC 715/781; 715/833

(57) ABSTRACT

An electronic device of adjusting a display scale of images is provided. The electronic device includes a storage unit, a display unit, and a processing unit. The storage unit stores a plurality of images. The display unit receives user operations and displays the images from the storage unit. The processing unit determines whether there is a sliding operation on the display unit when an image is displayed on the display unit, determines a sliding direction and a sliding track of the sliding operation when the sliding operation is on the display unit, and adjusts a display scale of the image on the display unit based on the determined sliding direction and the sliding track of the sliding operation.

### BACKGROUND

1. Technical Field

The present disclosure relates to electronic devices, and particularly to an electronic device and a method for adjusting a display scale of images.

2. Description of Related Art

In prior art, a multi-touch technology is usually used to enlarge or reduce a display scale of an image which is displayed on a touch screen. However, the multi-touch technologies need more than one fingers to achieve, it is inconvenient for user when only one finger is free.

Therefore, what is needed is an electronic device and a method for adjusting a display scale of images to overcome the above described limitations.

### BRIEF DESCRIPTION OF THE DRAWING

FIG. 1 is a block diagram of one embodiment of an electronic device.

FIG. 2 is a schematic diagram of adjusting a display scale of an image.

FIGS. 3-4 are schematic diagrams of adjusting a display scale of a portion of the image of FIG. 2.

FIG. 5 is flowchart of an embodiment of a method of adjusting a display scale of the image implemented by the electronic device of FIG. 1.

FIG. 6 is flowchart of an embodiment of a method of adjusting a display scale of a portion of the image implemented by the electronic device of FIG. 1.

### DETAILED DESCRIPTION

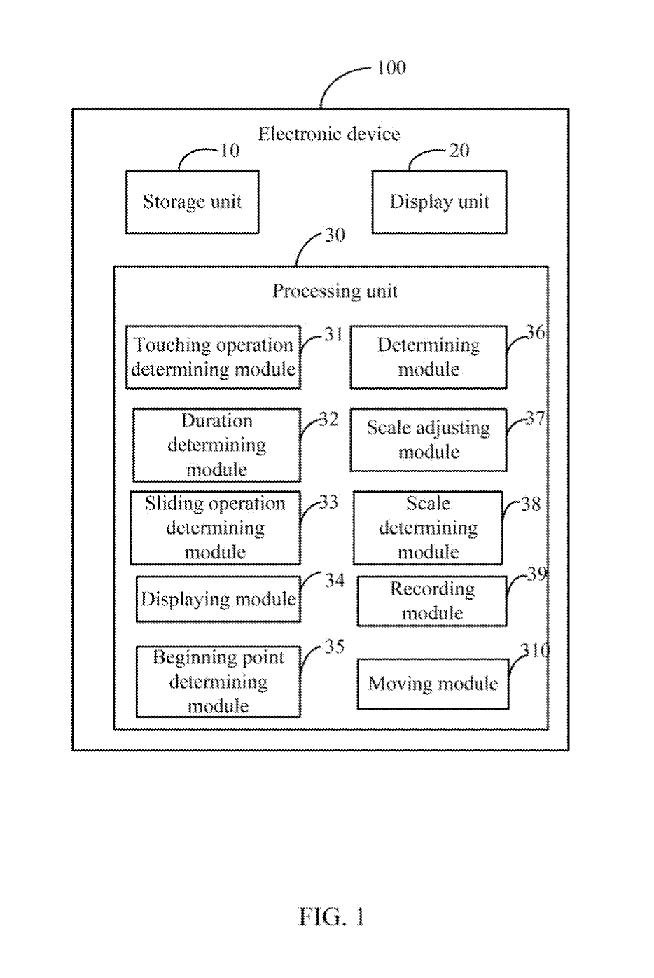

FIG. 1 shows an electronic device 100 for adjusting a display scale of an image. The electronic device 100 includes a storage unit 10, a display unit 20, and a processing unit 30. The storage unit 10 stores a number of images. The display unit 20 receives user operations such as touching operations or sliding operations, and displaying images.

In a first embodiment, the processing unit 30 includes a sliding operation determining module 33, a determining module 36, and a scale adjusting module 37 which are a collection of software instructions and executed by the processing unit 30. In one embodiment, the sliding operation defines an operation which slides on the display module 20 in only one direction. The sliding operation determining module 33 determines whether there is a sliding operation on the display unit 20 when there is an image being displayed on the display unit 20. The determining module 36 determines a sliding direction and a sliding track of the sliding operation when the sliding operation is on the display unit 20. The scale adjusting module 37 adjusts the display scale of the image on the display unit 20 based on the determined sliding direction and the sliding track of the sliding operation. In one embodiment, the scale adjusting module 37 determines an adjusting manner such as, enlarging or reducing the image, based on the sliding direction, determines an adjusting scale based on the sliding track, and adjusts the display scale of the image based on the determined adjusting manner and the adjusting scale.

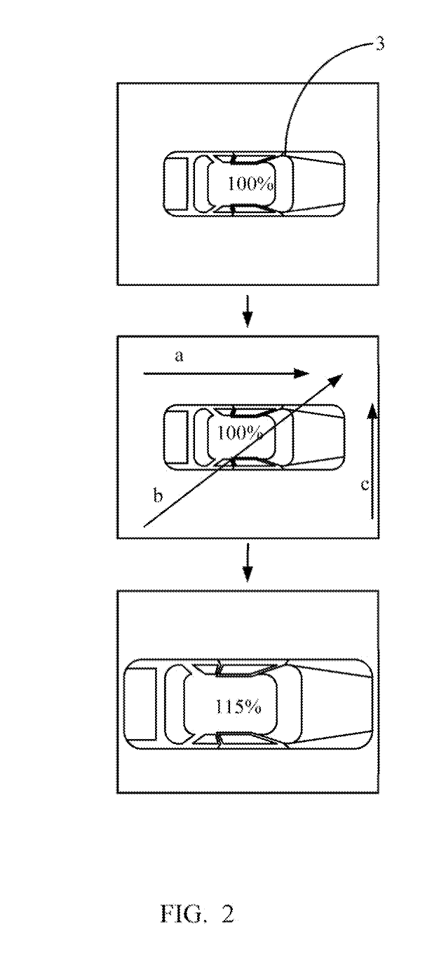

In a second embodiment, the processing unit 30 includes a touching operation determining module 31 and a duration determining module 32 which are collection of software instructions and executed by the processing unit 30. The touching operation determining module 31 determines whether there is a touching operation on the display unit 20 when the image is displayed on the display unit 20. The duration determining module 32 determines a duration of the touching operation on the display unit 20, and determines whether the duration exceeds a predetermined duration when the touching operation is on the display unit 20. The sliding operation determining module 33 determines whether there is the sliding operation when the duration of the touching operation on the display unit 20 exceeds the predetermined duration. As shown in FIG. 2, for example, the display unit 20 displays an image 3. There are three sliding tracks a, b, c for the user to select, but not limited to the three sliding tracks. The user can also define the sliding tracks by oneself. The user can slide to adjust the display scale of the image 3 when the duration of the touching operation on the display unit 20 exceeds the predetermined duration.

In a third embodiment, the processing unit 30 further includes a beginning point determining module 35 and a moving module 310 which are collection of software instructions and executed by the processing unit 30. The beginning point determining module 35 determines a beginning point of the sliding operation, and determines whether or not the beginning point is one of a number of predetermined beginning points on the display unit 20 after the determining module 36 determines the sliding direction and the sliding track of the sliding operation. The scale adjusting module 37 adjusts the display scale of the image 3 on the display unit 20 based on the sliding direction and the sliding track when the beginning point is one of the number of the predetermined beginning points. The moving module 310 moves the image on the display unit 20 based on the sliding direction and the sliding track of the sliding operation when the beginning point is not one of the number of the predetermined beginning points.

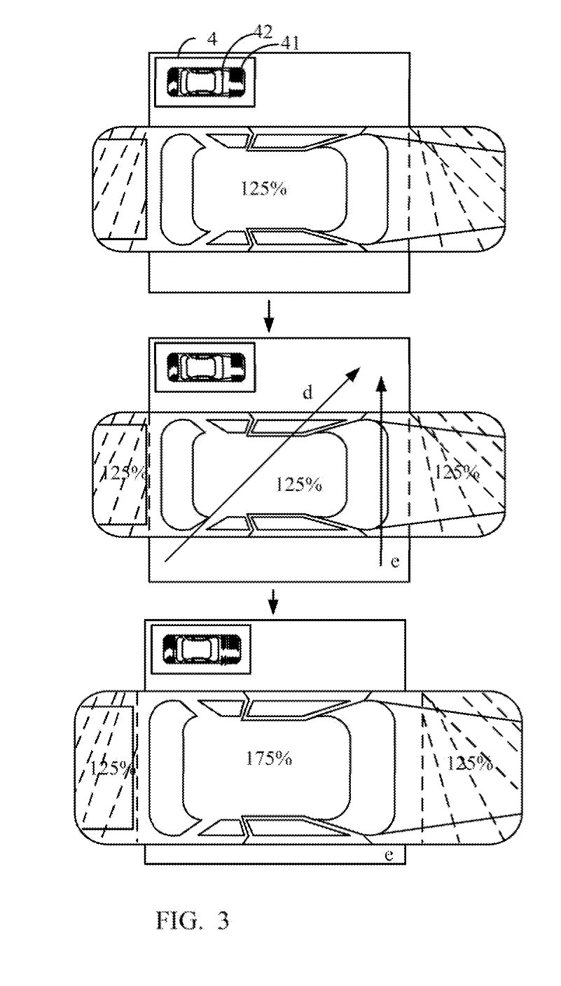

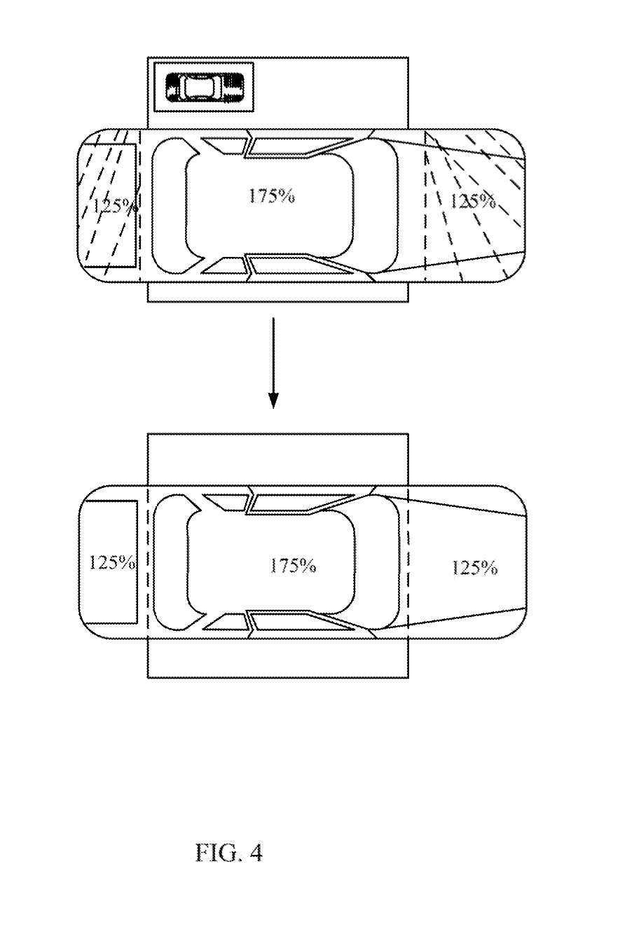

The processing unit 30 further includes a scale determining module 38, a display module 34, and a recording module 39 which are a collection of software instructions executed by the processing unit 30. The scale determining module 38 determines whether the display scale of the image is greater than a display scale of the display unit 20. The display module 34 displays a visual window 4 on the display unit 20 when the display scale of the image is greater than the display scale of the display unit 20. As shown in FIGS. 3-4, a visual window 4 is displayed on the upper-left portion of the display unit 20 when the display scale of the image 3 is greater than the display scale of the display unit 20. In another embodiment, the visual window 4 can be displayed at another position of the display unit 20 according to the requirements of the user. The visual window 4 displays a contracted image 40 of the image 3 on the display unit 20. The contracted image 40 includes a first portion 42 and a second portion 41. The first portion 42 is a contracted image of a portion of the image 3 which is visible on the display unit 20. The second portion 41 is a contracted image of a reminding portion of the image 3 which is hidden by the display unit 20. The first portion 42 of the contracted image 40 on the visual window 4 is visible, and the second portion 41 of the contracted image 40 on the visual window 4 is hidden by dotted lines. The first portion 42 is displayed on the visual window in a first displaying manner such as in a red color, and the second portion 41 is displayed on the visual window in a second displaying manner such as in a yellow color, which is different from the first displaying manner.

The sliding operation determining module 33 determines whether there is a sliding operation on the display unit 20 when the display scale of the image is greater than the display scale of the display unit 20. The determining module 36 determines the sliding direction and the sliding track of the sliding operation. The beginning point determining module 35 determines whether the beginning point is one of the number of the predetermined beginning points after the sliding direction and the sliding track of the sliding operation is determined. The scale adjusting module 37 adjusts the display scale of the portion of the image which is visible on the display unit 20 based on the determined sliding direction and the sliding track when the beginning point is one of the number of the predetermined beginning points. The moving module 310 moves the image on the display unit 20 based on the determined sliding direction and the sliding track when the beginning point is not one of the number of the predetermined beginning points. For example, when the display scale of the image 3 is greater than the display scale of the display unit 20, the display scale of the portion of the image which is visible on the display unit 20 is adjusted from 125% to 175%, and the display scale of the portion of the image which is hidden by the display unit 20, maintains 125%. During the process of adjusting the display scale of the image, the visual window 4 records the adjusted display scale of the portion of the image which is visible on the display unit 20 on the first portion 42, and records the display scale of the remaining portion of the image which is invisible on the second portion 41. Furthermore, the display scale of the first portion 42 and the second portion 41 of the contracted image on the visual window 4 will change based on the change of the display scale of the image 3 on the display unit 20.

The display module 34 further displays each portion of the contracted image on the display unit 20 based on the recorded display scale when the user touches the contracted image on the visual window 4.

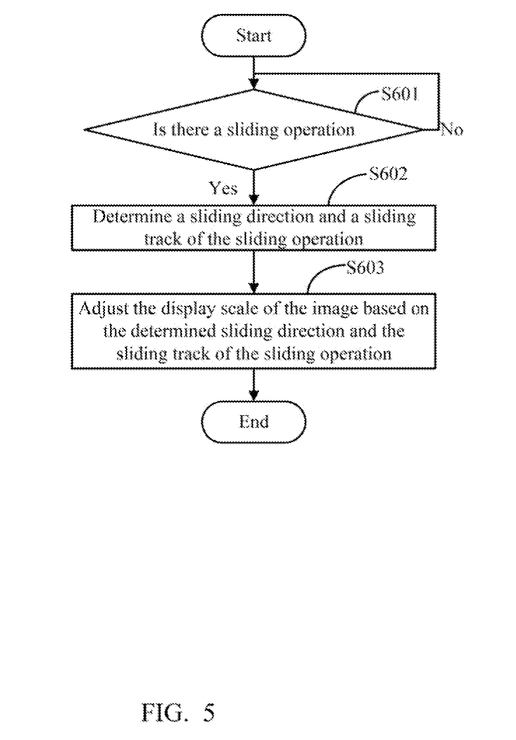

FIG. 5 is flowchart of an embodiment of a method for adjusting a display scale of the image implemented by the electronic device of FIG. 1.

In step S601, the sliding operation determining module 33 determines whether the sliding operation is on the display unit 20 when the image is displayed on the display unit 20. If so, the procedure goes to step S602, otherwise, the procedure goes to step S601.

In step S602, the determining module 36 determines the sliding direction and the sliding track of the sliding operation.

In step S603, the scale adjusting module 37 adjusts the display scale of the image on the display unit 20 based on the determined sliding direction and the sliding track of the sliding operation.

The method can further includes the following steps: the touching operation determining module 31 determines whether the touching operation is on the display unit 20 when the image is displayed on the display unit 20; the duration determining module 32 determines the duration of the touching operation on the display unit 20, and determines whether the duration exceeds the predetermined duration when the touching operation is on the display unit 20; and the sliding operation determining module 33 determines whether the sliding operation is on the display unit 20 when the duration of the touching operation exceeds the predetermined duration.

The method further can also includes the following steps: the beginning points determining module 35 determines whether the beginning point of the sliding operation is one of the number of predetermined beginning points after the determining module 36 determines the sliding direction and the sliding track of the sliding operation; the scale adjusting module 37 adjusts the display scale of the image based on the determined sliding direction and the sliding track of the sliding operation when the beginning point is one of the number of the predetermined beginning points; and the moving module 310 moves the image based on the sliding direction and the sliding track of the sliding operation when the beginning point is not one of the number of predetermined beginning points.

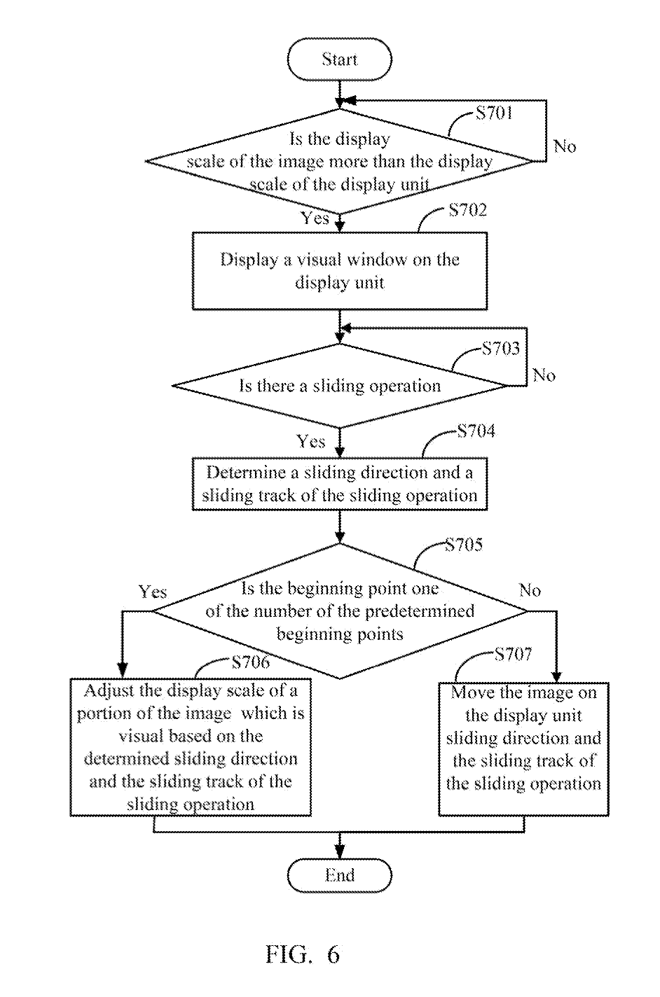

FIG. 6 is flowchart of an embodiment of a method for adjusting a display scale of a portion of the image implemented by the electronic device of FIG. 1.

In step S701, the scale determining module 38 determines whether the display scale of the image is greater than the display scale of the display unit 20, if yes, the procedure goes to step S702, if no, the procedure goes to step S701.

In step S702, the display module 34 displays the visual window 4 on the display unit 20.

In step S703, the sliding operation determining module 33 determines whether there is a sliding operation. If so, the procedure goes to step S704, otherwise, the procedure goes to step S703.

In step S704, the determining module 36 determines the sliding direction and the sliding track of the sliding operation.

In step S705, the beginning point determining module 35 determines whether the beginning point is one of the number of predetermined beginning points. If so, the procedure goes to step S706, otherwise, the procedure goes to S707.

In step S706, the scale adjusting module 37 adjusts the display scale of the image which is visible on the display unit 20 based on the sliding direction and the sliding track of the sliding operation.

In step S707, the moving module 310 moves the image on the display unit 22 based on the sliding direction and the sliding track of the sliding operation.

The method can further include the display module 34 displaying each portion of the contracted image on the display unit 20 based on the recorded display scale in response to the touching operation on the contracted image on the visual window 4.

Although various embodiments have been specifically described, the disclosure is not to be construed as being limited thereto. Various changes or modifications may be made to the embodiments without departing from the scope and spirit of the disclosure.

What is claimed is:

1. An electronic device of adjusting a display scale of images comprising:
a storage unit configured to store a plurality of images;
a display unit configured to receive user operations and display the images from the storage unit; and
a processing unit configured to determine whether there is a sliding operation on the display unit when an image is displayed on the display unit, determine a sliding direction and a sliding track of the sliding operation when the sliding operation is on the display unit, and adjust a display scale of the image on the display unit based on the determined sliding direction and the sliding track of the sliding operation.

2. The electronic device as described in claim 1, wherein the processing unit is further configured to determine whether there is a touching operation on the display unit when the image is displayed on the display unit, determine a duration of the touching operation on the display unit, determine whether the duration exceeds a predetermined duration, and determine whether the sliding operation is on the display unit when the duration of the touching operation exceeds the predetermined duration.

3. The electronic device as described in claim 1, wherein the processing unit is further configured to determine a beginning point of the sliding operation, determine whether the beginning point is one of a plurality of predetermined beginning points after the sliding direction and the sliding track of the sliding operation is determined, and adjust the display scale of the image on the display unit based on the determined sliding direction and the sliding track of the sliding operation when the beginning point of the sliding operation is one of the plurality of predetermined beginning points.

4. The electronic device as descried in claim 3, wherein the processing unit is further configured to moving the image on the display unit based on the determined sliding direction and the sliding track of the sliding operation when the beginning point of the sliding operation is not one of the plurality of predetermined beginning points.

5. The electronic device as described in claim 1, wherein the processing unit is further configured to determine whether the display scale of the image is greater than the display scale of the display unit, display a visual window on the display unit when the display scale of the image is greater than the display scale of the display unit, the visual window is configured to display a contracted image of the image on the display unit, the contracted image comprises a first portion and a second portion, the first portion is a contracted image of a portion of the image which is visible on the display unit, the second portion is a contracted image of a reminding portion of the image which is hidden by the display unit, the first portion of the contracted image is visible on the visual window, the second portion of the contracted image is hidden by a plurality of dotted lines on the visual window, the first portion of the contracted image is displayed on the visual window in a first displaying manner, and the second portion of the contracted image is displayed on the visual window in a second displaying manner which is different from the first displaying manner.

6. The electronic device as described in claim 5, wherein the processing unit is further configured to determine whether there is the sliding operation on the display unit when the display scale of the image is greater than the display scale of the display unit, determine the sliding direction and the sliding track of the sliding operation when there is the sliding operation, adjust a portion of the image which is visible on the display unit based on the determined sliding direction and the sliding track of the sliding operation, and record the adjusted display scale of the portion of the image in the contracted image on the visual window.

7. The electronic device as described in claim 6, wherein the processing unit is further configured to determine a beginning point of the sliding operation, determine whether the determined beginning point is one of the plurality of predetermined beginning points after the sliding direction and the sliding track of the sliding operation is determined, and adjust the display scale of the portion of the image which is visible on the display unit based on the sliding direction and the sliding track of the sliding operation when the beginning point is one of the plurality of predetermined beginning points.

8. The electronic device as described in claim 7, wherein the processing unit is further configured to move the image on the display unit based on the sliding direction and the sliding track of the sliding operation when the beginning point is not one of the plurality of predetermined beginning points.

9. The electronic device as described in claim 6, wherein the processing unit is further configured to display the portion of the contracted image on the display unit based on the recorded display scale in response to the touching operation on the contracted image on the visual window.

10. A method for adjusting a display scale of images implemented by an electronic device, wherein the electronic device comprises a storage unit and a display unit, the storage unit is configured to store a plurality of images, and the display unit is configured to receive user operations and display the images from the storage unit, the method comprising:
determining whether there is a sliding operation on the display unit when there is an image displayed on the display unit;
determining a sliding direction and a sliding track of the sliding operation when the sliding operation is on the display unit; and
adjusting the display scale of the image on the display unit based on the determined sliding direction and the sliding track of the sliding operation.

11. The method as described in claim 10, further comprising:
determining whether there is a touching operation on the display unit when the image is displayed on the display unit;
determining a duration of the touching operation on the display unit;
determining whether the duration exceeds a predetermined duration; and
determining whether there is the sliding operation on the display unit when the duration of the touching operation exceeds the predetermined duration.

12. The method as described in claim 10, further comprising:
determining a beginning point of the sliding operation;
determining whether the beginning point is one of a plurality of predetermined beginning points after the sliding direction and the sliding track of the sliding operation is determined; and
adjusting the display scale of the image on the display unit based on the determined sliding direction and the sliding track of the sliding operation when the beginning point of the sliding operation is one of the plurality of predetermine beginning points.

13. The method as descried in claim 12, further comprising moving the image on the display unit based on the determined sliding direction and the sliding track of the sliding operation when the beginning point of the sliding operation is not one of the plurality of predetermined beginning points.

14. The method as described in claim 10, further comprising:
determining whether a display scale of the image is greater than the display scale of the display unit; and
displaying a visual window on the display unit when the display scale of the image is greater than the display scale of the display unit, wherein the visual window is configured to display a contracted image of the image on the display unit, the contracted image comprises a first portion and a second portion, the first portion is a contracted image of a portion of the image which is visible, the second portion is a contracted image of a reminding portion of the image which is hidden by the display unit, the first portion of the contracted image is visible on the visual window, the second portion of the contracted image is hidden by a plurality of dotted lines on the visual window, the first portion of the contracted image is displayed in a first displaying manner, and the second portion of the contracted image is displayed in a second displaying manner which is different from the first displaying manner.

15. The method as described in claim 14, further comprising:
determining whether there is the sliding operation on the display unit when the display scale of the image is greater than the display scale of the display unit;
determining the sliding direction and the sliding track of the sliding operation when there is the sliding operation;
adjusting a portion of the image which is visible on the display unit based on the determined sliding direction and the sliding track of the sliding operation; and
recording the adjusted display scale of the portion of the image in the contracted image on the visual window.

16. The method as described in claim 15, further comprising:
determining a beginning point of the sliding operation;
determining whether the determined beginning point is one of the plurality of predetermined beginning points after the sliding direction and the sliding track of the sliding operation is determined; and
adjusting the display scale of the portion of the image which is visible on the display unit based on the sliding direction and the sliding track of the sliding operation when the beginning point is one of the plurality of predetermined beginning points.

17. The method as described in claim 16, further comprising moving the image on the display unit based on the sliding direction and the sliding track of the sliding operation when the beginning point is not one of the plurality of predetermined beginning points.

18. The method as described in claim 15, further comprising displaying the portion of the contracted image on the display unit based on the recorded display scale in response to the touching operation on the contracted image on the visual window.
